(19) United States
(12) Patent Application Publication
(10) Pub. No.: US 2013/0341280 A1
(43) Pub. Date: Dec. 26, 2013

(54) DEEP PURIFICATION METHOD FOR REMOVING TRACE THALLIUM IN WATER BY USING POLYMER-BASED NANOSIZED MANGANESE OXIDE

(71) Applicants: Lu Lv, Jiangsu (CN); Shunli Wan, Jiangsu (CN); Bingcai Pan, Jiangsu (CN); Weiming Zhang, Jiangsu (CN); Dong An, Jiangsu (CN)

(72) Inventors: Lu Lv, Jiangsu (CN); Shunli Wan, Jiangsu (CN); Bingcai Pan, Jiangsu (CN); Weiming Zhang, Jiangsu (CN); Dong An, Jiangsu (CN)

(73) Assignees: JIANGSU YONGTAI ENVIRONMENTAL PROTECTION TECHNOLOGY CO., LTD., Suzhou, Jiangsu (CN); NANJING UNIVERSITY, Nanjing, Jiangsu (CN)

(21) Appl. No.: 14/003,837

(22) PCT Filed: May 4, 2011
(86) PCT No.: PCT/CN2011/073633

§ 371 Date: Sep. 9, 2013

(30) Foreign Application Priority Data
Mar. 10, 2011 (CN) 201110057640.2

(51) Int. Cl. C02F 1/62

(52) U.S. Cl. CPC C02F 1/62; B82Y 30/00
USPC 210/669; 977/773; 977/902

(57) ABSTRACT

A deep purification method for removing trace thallium in water by using polymer-based nanosized manganese oxide is disclosed. This method comprising the following steps: adjusting the pH value of the water polluted with trace thallium to 5-8.5 and filtering it, then channeling the water so treated through a packed tower of filtering bed packed with polymer-based nanosized manganese oxide so that the thallium in water can be selectively adsorbed upon the nanocomposite material, stopping the adsorption process when the thallium in water reaches the leak point, and then using mixed solution of HCl—Ca(NO₃)₂ or NaOH—NaClO as the desorption agent and starting desorption and regeneration process for the packing material of polymer-based nanosized manganese oxide. This effectively reduces the concentration of thallium in water from 0.01-0.5 mg/L to lower than 0.1 μg/L, despite the much higher concentration of coexisting competitive cations such as Ca²⁺, Mg²⁺, Na⁺ and Si(IV).

### FIELD OF TECHNOLOGY

This invention relates to a deep purification method for removing trace thallium in water, specifically to a deep purification method for removing trace thallium by adopting a type of manganese oxide nanocomposite material of high adsorption capacity and high selectivity.

### BACKGROUND

Thallium is one of chemical elements naturally exists in the Earth's crust. It can be found in trace amount in various environmental media, however, human activities such as mining, quarrying and metal smelting often result in great increase of thallium concentration in local waters and soil. Thallium bears very high accumulative toxicity. Its lethal dosage for an adult is 10-15 mg/kg, which means that it presents much stronger toxic effect upon mammals than mercury (Hg), lead (Pb) and arsenic (As). The overdose intake of thallium will lead to such symptoms as loss of hair, diarrhea, muscle atrophy, and permanent injury of the nervous system. In respect of the high toxicity of thallium, the U.S. Environmental Protection Agency (EPA) stipulates that the maximum amount of thallium in drinking water of 2 μg/L; in accordance to the Standards for Drinking Water Quality promulgated by Chinese government, the maximum amount of thallium in drinking water of 0.1 μg/L.

Currently, there are insufficient and ineffective technologies available for purifying thallium-polluted water. The U.S. EPA recommends that the active aluminum purification method and the ion exchange method can be used in purifying thallium-polluted water, however, both methods present high operation cost and inefficient purification effect. Some literature reports that the chemical precipitation method (for example, sulfide precipitation) can be adopted for removing thallium in water; this method is simple in operation but is liable to secondary pollution, and its purification effect is also ineffective. In recent years, some researchers advocate removing thallium in water by using the adsorption method. Due to the chemical properties of thallium quite similar to alkaline metals and obviously different from those of heavy metal ions, generally speaking, the adsorbents currently used for removing thallium present low selectivity and poor regeneration rate, which consequently does not guarantee a bright prospect for future practicality. In summary, currently, a highly economical and efficient deep-treatment method for purifying thallium-polluted water is in urgent need throughout the world.

In recent decades, various researches have shown that nanosized manganese oxide grains present high adsorption selectivity for such heavy metals as lead (Pb), cadmium (Cd), mercury (Hg) and Cerium (Ce), and through adjustment of pH value, the nanocomposite material can be regenerated and reused. However, since the grain size of nanosized manganese oxide is very small (generally several micrometer to several nanometer), when directly used for fixed-bed adsorption, they will result in extremely large fluid pressure drop and consequently fail the whole adsorption system. In order to solve this technical problem, the inventor of this invention, Professor Pan Bingcai and his team from Nanjing University, China, invented a new type of nanocomposite material by taking polymer resin as the carrier, and then, with the inner-surface deposit method, loading nanosized hydrated manganese oxide particles upon the surface of pore canals of the polymer resin; the nanocomposite material so obtained has been successfully used for deep purification of water containing such regular heavy metals as lead (Pb), cadmium (Cd) and zinc (Zn). [“Fabrication of Polymer-supported Nanosized Hydrous Manganese Dioxide (HMO) for Enhanced Lead Removal from Waters.” Science of the Total Environment 2009, 407, 5471-5477; “Selective Adsorption of Cd(II) and Zn(II) Ions by Nano-Hydrous Manganese Dioxide (HMO)-Encapsulated Cation Exchanger.” Industrial Engineering & Chemistry Research 2010, 49, 7474-7579.]. It not only successfully solves the problem of large pressure drop occurred when the nanosized manganese oxide grains are directly applied in the fluidization system, but also greatly enhances adsorption selectivity of the material for the target pollutant and its adsorption capacity by means of the Donnan membrane effect engendered by fixed surface charge of the resin. However, due to the specific properties of thallium very similar to alkaline metals but quite different from heavy metals, one cannot be sure if manganese oxide can form specific interactions with thallium ions and if the nanocomposite material so obtained can present good effect in removing thallium from water.

### SUMMARY

### 1. The Technical Problems to be Solved

Whereas the existing technologies are not effective enough in deep purification of water polluted with trace thallium, this invention provides a new deep purification method for removing trace thallium in water by using polymer-based nanosized manganese oxide, which, despite the much higher concentration of coexisting competitive cations such as Ca²⁺, Mg²⁺, Na⁺ and K⁺, can still effectively guarantee the concentration of thallium in the effluent lower than the drinking-water standard stipulated by Chinese government.

### 2. Technical Solutions

A deep purification method for removing trace thallium in water by using polymer-based nanosized manganese oxide, comprising the following steps:
(A) adjusting the pH value of the water polluted with trace thallium to 5˜8.5 and then filtering the water;
(B) channeling the water treated by step (A) through a packed tower or filtering bed packed with polymer-based nanosized manganese oxide so that the thallium contained therein can be selectively adsorbed upon the said nanocomposite material;
(C) stopping the adsorption process when thallium in the effluent reaches the breakthrough point, and then using mixed solution of HCl and Ca(NO₃)₂ as the desorption agent and starting desorption and regeneration process for the packing material of polymer-based nanosized manganese oxide mentioned in step (B); the regenerated packing material can be used repeatedly;

the concentration of thallium in the thallium-polluted water mentioned in step (A) is 0.01-0.5 mg/L; and the respective concentration of all coexisting competitive cations such as K⁺, Ca²⁺, Mg²⁺, Na⁺ and Sr²⁺ is lower than 50 mg/L;

during step (B), controlling the temperature at 5-50° C. and channeling the water treated by step (A) through the packed tower or filtering bed packed with polymer-based nanosized manganese oxide at the flow rate of 10-100 BV/h (BV referring to resin bed volume). The carrier of the said nanocomposite material is cation exchange resin, preferably D001 manufactured by (China) Hangzhou Zhengguang Resin Co., Ltd., D113 and 001×7 manufactured by (Jiangsu, China) Yongtai Environmental Protection Science and Technology Co., Ltd., and Amberlite IR 252 manufactured by (U.S.) Rahm Haas Company; the loaded material is nanosized manganese oxide grains, the size of which is 5-180 nm and the loading amount is controlled at 4-15% (calculated in manganese mass).

during step (C), controlling the temperature at 10-60° C. and introducing the said desorption agent through the nanocomposite material at the flow rate of 0.5-10 BV/h so that the said nanocomposite material can be desorbed and regenerated. The mass concentration of the said mixed solution of HCl and Ca(NO₃)₂ in step (C) is 0.3-5%.

### 3. Beneficial Effects

This invention provides a new method for deep purification of water polluted with trace thallium by adopting an organic-inorganic composite material loaded with nanosized manganese oxide grains as the adsorbent. The method disclosed herein is characteristic of the following benefits: \textcircled{1} this method can nonetheless guarantee deep treatment of trace thallium in the water and reduce the concentration of thallium in the effluent to less than 0.1 μg/L despite the much higher concentration of coexisting competitive cations such as Ca²⁺, Mg²⁺, Na⁺, K⁺ and Sr²⁺. \textcircled{2} this type of nanocomposite material enjoys huge adsorption capacity, fast adsorption speed, thorough regenerability and capability for repeated use. \textcircled{3} this method is a breakthrough in providing an economical, highly efficient technical solution for treating the water polluted with trace thallium.

### DETAILED DESCRIPTION

The following embodiments are adopted for further illustration of this invention:

### Embodiment 1

Channeling the pretreated water polluted with trace thallium through a polystyrene adsorption column packed with polymer-based nanosized manganese oxide. In the water polluted with trace thallium, the concentration of respective ions is Tl+: 400 μg/L; Tl³⁺:50 μg/L; Ca²⁺: 20 mg/L; Mg²⁺: 25 mg/L; Na⁺: 35 mg/L; K⁺: 15 mg/L; and the pH value of the water is 3.5. Adding in an appropriate amount of NaOH solution to adjust the pH value to 7, and then filtering the thallium-polluted water before channeling it into the adsorption column for adsorption. The size of adsorption column is 50×360 mm; it is packed with 100 mL (about 148 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 10.2% (calculated in manganese), while the grain size of the said manganese oxide (above 80%) is 10-50 nm. Controlling the temperature at 25±5° C. and channeling the water polluted with trace thallium through the resin bed at the flow rate of 10 BV/h; the total treatment capacity is 1050 BV and the total thallium in the effluent is lower than 0.1 μg/L.

Controlling the temperature at 30±5° C. and co-currently introducing 800 mL of mixed solution of 0.3% HCl and 5% Ca(NO₃)₂ (by mass concentration) at the flow rate of 100 mL/h through the resin bed for desorption; the desorption rate is higher than 99%.

### Embodiment 2

Channeling the pretreated water polluted with trace thallium through a polystyrene adsorption column packed with polymer-based nanosized manganese oxide. In the water polluted with trace thallium, the concentration of respective ions is Tl⁺: 400 μg/L; Tl³⁺: 50 μg/L; Ca²⁺: 20 mg/L; Mg²⁺: 15 mg/L; Na⁺: 35 mg/L; K⁺: 15 mg/L; and the pH value of the water is 3.5. Adding in an appropriate amount of NaOH solution to adjust the pH value to 7.5, and then filtering the thallium-polluted water before channeling it into the adsorption column for adsorption. The size of adsorption column is 50×360 mm; it is packed with 100 mL (about 148 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 10.2% (calculated in manganese), while the grain size of the said manganese oxide (above 80%) is 10-50 nm. Controlling the temperature at 5±2° C. and channeling the water polluted with trace thallium through the resin bed at the flow rate of 10 BV/h; the total treatment capacity is 1030 BV and the total thallium in the effluent is lower than 0.1 μg/L.

Controlling the temperature at 30±5° C. and co-currently introducing 800 mL of mixed solution of 0.4% HCl and 5% Ca(NO₃)₂ (by mass concentration) at the flow rate of 100 mL/h through the resin bed for desorption; the desorption rate is higher than 99%.

### Embodiment 3

Channeling the pretreated water polluted with trace thallium through a polystyrene adsorption column packed with polymer-based nanosized manganese oxide material. In the water polluted with trace thallium, the concentration of respective ions is Tl⁺: 450 μg/L; Tl³⁺: 50 μg/L; Ca²⁺: 20 mg/L; Mg²⁺: 25 mg/L; Na⁺: 35 mg/L; K⁺: 15 mg/L; and the pH value of the water is 3.5. Adding in an appropriate amount of NaOH solution to adjust the pH value to 5, and then filtering the thallium-polluted water before channeling it into the adsorption column for adsorption. The size of adsorption column is 50×360 mm; it is packed with 100 mL (about 135 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 10.2% (calculated in manganese), while the grain size of the said manganese oxide (above 80%) is 10-50 nm. Controlling the temperature at 45±5° C. and channeling the water polluted with trace thallium through the resin bed at the flow rate of 10 BV/h; the total treatment capacity is 1130 BV and the total thallium in the effluent is lower than 0.1 μg/L.

Controlling the temperature at 30±5° C. and co-currently introducing 800 mL of mixed solution of 0.3% HCl and 5% Ca(NO₃)₂ (by mass concentration) at the flow rate of 100 mL/h through the resin bed for desorption; the desorption rate is higher than 99%.

### Embodiment 4

Channeling the pretreated water polluted with trace thallium through a polystyrene adsorption column packed with polymer-based nanosized manganese oxide. In the water polluted with trace thallium, the concentration of respective ions is Tl⁺: 400 μg/L; Tl³⁺: 50 μg/L; Ca²⁺: 20 mg/L; Mg²⁺: 25 mg/L; Na⁺: 35 mg/L; K⁺: 15 mg/L; and the pH value of the water is 4. Adding in an appropriate amount of NaOH solution to adjust the pH value to 8.5, and then filtering the thallium-polluted water before channeling it into the adsorption column for adsorption. The size of adsorption column is 50×360 mm; it is packed with 100 mL (about 137 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 4.3% (calculated in manganese), while the grain size of the said manganese oxide (above 85%) is 5-40 nm. Controlling the temperature at 30±5° C. and channeling the water polluted with trace thallium through the resin bed at the flow rate of 10 BV/h; the total treatment capacity is 950 BV and the total thallium in the effluent is lower than 0.1 μg/L.

Controlling the temperature at 50±5° C. and co-currently introducing 800 mL of mixed solution of 0.5% HCl and 3% Ca(NO₃)₂ (by mass concentration) at the flow rate of 200 mL/h through the resin bed for desorption; the desorption rate is higher than 99%.

### Embodiment 5

Channeling the pretreated water polluted with trace thallium through a polystyrene adsorption column packed with polymer-based nanosized manganese oxide. In the water polluted with trace thallium, the concentration of respective ions is Tl⁺: 200 μg/L; Tl³⁺: 18 μg/L; Ca²⁺: 14 mg/L; Mg²⁺: 15 mg/L; Na⁺: 24 mg/L; K⁺: 10 mg/L; and the pH value of the water is 5. Adding in an appropriate amount of NaOH solution to adjust the pH value to 6, and then filtering the thallium-polluted water before channeling it into the adsorption column for adsorption. The size of adsorption column is o50×360 mm; it is packed with 100 mL (about 137 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 4.3% (calculated in manganese), while the grain size of the said manganese oxide (above 85%) is 5-40 nm. Controlling the temperature at 20±5° C. and channeling the water polluted with trace thallium through the resin bed at the flow rate of 20 BV/h; the total treatment capacity is 2100 BV and the total thallium in the effluent is lower than 0.1 μg/L.

Controlling the temperature at 10±2° C. and co-currently introducing 1000 mL of mixed solution of 0.8% HCl and 4% Ca(NO3)2 (by mass concentration) at the flow rate of 500 mL/h through the resin bed for desorption; the desorption rate is higher than 98.5%.

### Embodiment 6

Channeling the pretreated water polluted with trace thallium through a polystyrene adsorption column packed with polymer-based nanosized manganese oxide. In the water polluted with trace thallium, the concentration of respective ions is Tl⁺: 200 μg/L; Tl³⁺: 25 μg/L; Ca²⁺: 14 mg/L; Mg²⁺: 15 mg/L; Na⁺: 24 mg/L; K⁺: 10 mg/L; and the pH value of the water is 4.5. Adding in an appropriate amount of NaOH solution to adjust the pH value to 5, and then filtering the thallium-polluted water before channeling it into the adsorption column for adsorption. The size of adsorption column is o50×360 mm; it is packed with 100 mL (about 137 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 4.3% (calculated in manganese), while the grain size of the said manganese oxide (above 85%) is 5-40 nm. Controlling the temperature at 40±5° C. and channeling the water polluted with trace thallium through the resin bed at the flow rate of 30 BV/h; the total treatment capacity is 1900 BV and the total thallium in the effluent is lower than 0.1 μg/L.

Controlling the temperature at 50±2° C. and co-currently introducing 1000 mL of mixed solution of 0.8% HCl and 4% Ca(NO₃)₂ (by mass concentration) at the flow rate of 200 mL/h through the resin bed for desorption; the desorption rate is higher than 99.5%.

### Embodiment 7

Channeling the pretreated water polluted with trace thallium through a polystyrene adsorption column packed with polymer-based nanosized manganese oxide. In the water polluted with trace thallium, the concentration of respective ions is Tl⁺: 130 μg/L; Tl³⁺: 12 μg/L; Ca²⁺: 16 mg/L; Mg²⁺: 7 mg/L; Na⁺: 18 mg/L; K⁺: 1 mg/L; and the pH value of the water is 5.5. Adding in an appropriate amount of NaOH solution to adjust the pH value to 7.5, and then filtering the thallium-polluted water before channeling it into the adsorption column for adsorption. The size of adsorption column is g20×300 mm; it is packed with 20 mL (about 26 g) of wet material of polymer-based nanosized manganese oxide. The carrier of the said material is 001×7 resin manufactured by (China) Yongtai Environmental Protection Science and Technology Co., Ltd.; this resin takes polystyrene-divinylbenzene as its matrix, and its crosslinkage is 7% and the size of resin grains 0.4-0.6 mm, the average pore size 4.2 nm, the content of surface-bonded sulfonates 4.9 mmol/g; the loading rate of manganese oxide is 5.7% (calculated in manganese), while the grain size of the said manganese oxide (above 80%) is 5-60 nm. Controlling the temperature at 10±2° C. and channeling the water polluted with trace thallium through the resin bed at the flow rate of 35 BV/h; the total treatment capacity is 3100 BV and the total thallium in the effluent is lower than 0.1 μg/L.

Controlling the temperature at 40±5° C. and co-currently introducing 180 mL of mixed solution of 0.7% HCl and 5% Ca(NO₃)₂ (by mass concentration) at the flow rate of 100 mL/h through the resin bed for desorption; the desorption rate is higher than 98.7%.

### Embodiment 8

Channeling the pretreated water polluted with trace thallium through a polystyrene adsorption column packed with polymer-based nanosized manganese oxide. In the water polluted with trace thallium, the concentration of respective ions is Tl⁺: 90 μg/L; Tl³⁺: 15 μg/L; Ca²⁺: 12 mg/L; Mg²⁺: 8 mg/L; Na⁺: 13 mg/L; K⁺: 6 mg/L; and the pH value of the water is 9.5. Adding in an appropriate amount of HCl solution to adjust the pH value to 8, and then filtering the thallium-polluted water before channeling it into the adsorption column for adsorption. The size of adsorption column is 32×360 mm; it is packed with 50 mL (about 75 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 13.5% (calculated in manganese), while the grain size of the said manganese oxide (above 90%) is 20-100 nm. Controlling the temperature at 35±5° C. and channeling the water polluted with trace thallium through the resin bed at the flow rate of 45 BV/h; the total treatment capacity is 3920 BV and the total thallium in the effluent is lower than 0.1 μg/L.

Controlling the temperature at 20±5° C. and co-currently introducing 400 mL of mixed solution of 0.6% HCl and 4% Ca(NO₃)₂ (by mass concentration) at the flow rate of 200 mL/h through the resin bed for desorption; the desorption rate is higher than 99%.

### Embodiment 9

Channeling the pretreated water polluted with trace thallium through a polystyrene filtering bed packed with polymer-based nanosized manganese oxide. In the water polluted with trace thallium, the concentration of respective ions is Tl⁺: 70 μg/L; Tl³⁺: 2 μg/L; Ca²⁺: 7 mg/L; Mg²⁺: 5 mg/L; Na⁺: 10 mg/L; K⁺: 2 mg/L; and the pH value of the water is 4.5. Adding in an appropriate amount of NaOH solution to adjust the pH value to 6.5, and then filtering the thallium-polluted water before channeling it into the adsorption column for adsorption. The size of adsorption column is o50×360 mm; it is packed with 100 mL (about 129 g) of wet material of polymer-based nanosized manganese oxide. The carrier of the said material is Amberlitte IR 252 manufactured by (U.S.) Rohm Haas Company; the loading rate of manganese oxide is 4.5% (calculated in manganese), while the grain size of the said manganese oxide (above 85%) is 5-40 nm. Controlling the temperature at 35 a 5° C. and channeling the water polluted with trace thallium through the resin bed at the flow rate of 45 BV/h; the total treatment capacity is 5800 BV and the total thallium in the effluent is lower than 0.1 μg/L.

Controlling the temperature at 50±5° C. and co-currently introducing 800 mL of mixed solution of 0.3% HCl and 2.5% Ca(NO₃)₂ (by mass concentration) at the flow rate of 200 mL/h through the resin bed for desorption; the desorption rate is higher than 99%.

### Embodiment 10

Channeling the pretreated water polluted with trace thallium through a polystyrene adsorption column packed with polymer-based nanosized manganese oxide material. In the water polluted with trace thallium, the concentration of respective ions is Tl⁺: 10 μg/L; Tl³⁺: 2 μg/L; Ca²⁺: 8 mg/L; Mg²⁺: 6 mg/L; Na⁺: 13 mg/L; K⁺: 2 mg/L; and the pH value of the water is 6. Adding in an appropriate amount of NaOH solution to adjust the pH value to 7, and then filtering the thallium-polluted water before channeling it into the adsorption column for adsorption. The size of adsorption column is o20×300 mm; it is packed with 20 mL (about 25 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 8.5% (calculated in manganese), while the grain size of the said manganese oxide (above 90%) is 20-100 nm. Controlling the temperature at 35±5° C. and channeling the water polluted with trace thallium through the resin bed at the flow rate of 95 BV/h; the total treatment capacity is 16800 BV and the total thallium in the effluent is lower than 0.1 μg/L.

Controlling the temperature at 45±5° C. and co-currently introducing 400 mL of mixed solution of 0.8% HCl and 4.5% Ca(NO₃)₂ (by mass concentration) at the flow rate of 200 mL/h through the resin bed for desorption; the desorption rate is higher than 99%.

### Embodiment 11

Channeling the pretreated water polluted with trace thallium through a polystyrene adsorption column packed with polymer-based nanosized manganese oxide. In the water polluted with trace thallium, the concentration of respective ions is Tl⁺: 9 μg/L; Tl³⁺: 1 μg/L; Ca²⁺: 2 mg/L; Mg²⁺: 1 mg/L; Na⁺: 6 mg/L; K⁺: 2 mg/L; and the pH value of the water is 6. Adding in an appropriate amount of NaOH solution to adjust the pH value to 7.5, and then filtering the thallium-polluted water before channeling it through the filtering bed. The size of the filtering bed is L100×B100×H400 mm; it is packed with 2500 mL (about 3425 g) of wet material of polymer-based nanosized manganese oxide. The carrier of the said material is 001×7 resin manufactured by (China) Yongtai Environmental Protection Science and Technology Co., Ltd.; this resin takes polystyrene-divinylbenzene as its matrix, and its crosslinkage is 7% and the size of resin grains 0.4-0.6 mm, the average pore size 4.2 nm, the content of surface-bonded sulfonates 4.9 mmol/g; the loading rate of manganese oxide is 8.5% (calculated in manganese), while the grain size of the said manganese oxide (above 85%) is 5-60 nm. Controlling the temperature at 45±5° C. and channeling the water polluted with trace thallium through the resin bed at the flow rate of 100 BV/h; the total treatment capacity is 15700 BV and the total thallium in the effluent is lower than 0.1 μg/L.

Controlling the temperature at 30±5° C. and co-currently introducing 25000 mL of mixed solution of 0.4% HCl and 4.5% Ca(NO₃)₂ (by mass concentration) at the flow rate of 2000 mL/h through the resin bed for desorption; the desorption rate is higher than 99%.

### Embodiment 12

Channeling the pretreated water polluted with trace thallium through a polystyrene filtering bed packed with polymer-based nanosized manganese oxide. In the water polluted with trace thallium, the concentration of respective ions is Tl⁺: 50 μg/L; Tl³⁺: 2 μg/L; Ca²⁺: 7 mg/L; Mg²⁺: 5 mg/L; Na⁺: 14 mg/L; K⁺: 3 mg/L; and the pH value of the water is 6. Adding in an appropriate amount of NaOH solution to adjust the pH value to 7.5, and then filtering the thallium-polluted water before channeling it through the filtering bed. The size of the filtering bed is L100×B100×H400 mm; it is packed with 2500 mL (about 3425 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 6% (calculated in manganese), while the grain size of the said manganese oxide (above 85%) is 5-40 nm. Controlling the temperature at 15±5° C. and channeling the water polluted with trace thallium through the resin bed at the flow rate of 50 BV/h; the total treatment capacity is 6700 BV and the total thallium in the effluent is lower than 0.1 μg/L.

Controlling the temperature at 20±5° C. and co-currently introducing 20000 mL of mixed solution of 0.9% HCl and 4.5% Ca(NO₃)₂ (by mass concentration) at the flow rate of 2000 mL/h through the resin bed for desorption; the desorption rate is higher than 99%.

### Embodiment 13

Channeling the pretreated water polluted with trace thallium through a polystyrene filtering bed packed with polymer-based nanosized manganese oxide. In the water polluted with trace thallium, the concentration of respective ions is Tl⁺: 60 μg/L; Tl³⁺: 5 μg/L; Ca²⁺: 6 mg/L; Mg²⁺: 7 mg/L; Na⁺: 10 mg/L; K⁺: 4 mg/L; and the pH value of the water is 4.5. Adding in an appropriate amount of NaOH solution to adjust the pH value to 5.5, and then filtering the thallium-polluted water before channeling it into the adsorption column for adsorption. The size of adsorption column is o50×360 mm; it is packed with 100 mL (about 139 g) of wet material of polymer-based nanosized manganese oxide. The carrier of the said material is 001×7 resin manufactured by (China) Yongtai Environmental Protection Science and Technology Co., Ltd.; this resin takes polystyrene-divinylbenzene as its matrix, and its crosslinkage is 7% and the size of resin grains 0.4-0.6 mm, the average pore size 4.2 nm, the content of surface-bonded sulfonates 4.9 mmol/g; the loading rate of manganese oxide is 8.7% (calculated in manganese), while the grain size of the said manganese oxide (above 85%) is 10-60 nm. Controlling the temperature at 45±5° C. and channeling the water polluted with trace thallium through the resin bed at the flow rate of 45 BV/h; the total treatment capacity is 6100 BV and the total thallium in the effluent is lower than 0.1 μg/L.

Controlling the temperature at 50±5° C. and co-currently introducing 1000 mL of mixed solution of 0.9% HCl and 4.5% Ca(NO₃)₂ (by mass concentration) at the flow rate of 200 mL/h through the resin bed for desorption; the desorption rate is higher than 99%.

### Embodiment 14

Channeling the pretreated water polluted with trace thallium through a polystyrene filtering bed packed with polymer-based nanosized manganese oxide. In the water polluted with trace thallium, the concentration of respective ions is Tl⁺: 300 μg/L; Tl³⁺: 35 μg/L; Ca²⁺: 46 mg/L; Mg²⁺: 37 mg/L; Na⁺: 15 mg/L; K⁺: 7 mg/L; and the pH value of the water is 8.5. Adding in an appropriate amount of HCl solution to adjust the pH value to 6.5, and then filtering the thallium-polluted water before channeling it into the adsorption column for adsorption. The size of adsorption column is o32×360 mm; it is packed with 50 mL (about 74 g) of wet material of polymer-based nanosized manganese oxide. The carrier of the said material is 001×7 resin manufactured by (China) Yongtai Environmental Protection Science and Technology Co., Ltd.; this resin takes polystyrene-divinylbenzene as its matrix, and its crosslinkage is 7% and the size of resin grains 0.4-0.6 mm, the average pore size 4.2 nm, the content of surface-bonded sulfonates 4.9 mmol/g; the loading rate of manganese oxide is 14.7% (calculated in manganese), while the grain size of the said manganese oxide (above 85%) is 100-160 nm. Controlling the temperature at 25±5° C. and channeling the water polluted with trace thallium through the resin bed at the flow rate of 15 BV/h; the total treatment capacity is 1400 BV and the total thallium in the effluent is lower than 0.1 μg/L.

Controlling the temperature at 20±5° C. and co-currently introducing 600 mL of mixed solution of 0.5% HCl and 3% Ca(NO₃)₂ (by mass concentration) at the flow rate of 400 mL/h through the resin bed for desorption; the desorption rate is higher than 99%.

### Embodiment 15

Channeling the pretreated water polluted with trace thallium through a polystyrene adsorption column packed with polymer-based nanosized manganese oxide. In the water polluted with trace thallium, the concentration of respective ions is Tl⁺: 100 μg/L; Tl³⁺: 35 μg/L; Ca²⁺: 16 mg/L; Mg²⁺: 8 mg/L; Na⁺: 9 mg/L; K⁺: 6 mg/L; and the pH value of the water is 5. Adding in an appropriate amount of NaOH solution to adjust the pH value to 7, and then filtering the thallium-polluted water before channeling it into the adsorption column for adsorption. The size of adsorption column is of it into the e to 7, and the 100 mL (about 157 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 15% (calculated in manganese), while the grain size of the said manganese oxide (above 90%) is 100-150 nm. Controlling the temperature at 25±5° C. and channeling the water polluted with trace thallium through the resin bed at the flow rate of 40 BV/h; the total treatment capacity is 3850 BV and the total thallium in the effluent is lower than 0.1 μg/L.

Controlling the temperature at 40±5° C. and co-currently introducing 800 mL of mixed solution of 1% HCl and 2% Ca(NO₃)₂ (by mass concentration) at the flow rate of 100 mL/h through the resin bed for desorption; the desorption rate is higher than 99%.

### Embodiment 16

Channeling the pretreated water polluted with trace thallium through a polystyrene filtering bed packed with polymer-based nanosized manganese oxide. In the water polluted with trace thallium, the concentration of respective ions is Tl⁺: 50 μg/L; Tl³⁺: 4 μg/L; Ca²⁺: 5 mg/L; Mg²⁺: 3 mg/L; Na⁺: 11 mg/L; K⁺: 1 mg/L; and the pH value of the water is 5. Adding in an appropriate amount of NaOH solution to adjust the pH value to 8.5, and then filtering the thallium-polluted water before channeling it through the filtering bed. The size of the filtering bed is L100×B50×H400 mm; it is packed with 1000 mL (about 1420 g) of wet material of polymer-based nanosized manganese oxide. The carrier of the said material is 001×7 resin manufactured by (China) Yongtai Environmental Protection Science and Technology Co., Ltd.; this resin takes polystyrene-divinylbenzene as its matrix, and its crosslinkage is 7% and the size of resin grains 0.4-0.6 mm, the average pore size 4.2 nm, the content of surface-bonded sulfonates 4.9 mmol/g; the loading rate of manganese oxide is 10.8% (calculated in manganese), while the grain size of the said manganese oxide (above 85%) is 10-50 nm. Controlling the temperature at 15±5° C. and channeling the water polluted with trace thallium through the resin bed at the flow rate of 70 BV/h; the total treatment capacity is 7000 BV and the total thallium in the effluent is lower than 0.1 μg/L.

Controlling the temperature at 55±5° C. and co-currently introducing 8000 mL of mixed solution of 0.3% HCl and 3% Ca(NO₃)₂ (by mass concentration) at the flow rate of 500 mL/h through the resin bed for desorption; the desorption rate is higher than 99%.

### Embodiment 17

Channeling the pretreated water polluted with trace thallium through a polystyrene filtering bed packed with polymer-based nanosized manganese oxide. In the water polluted with trace thallium, the concentration of respective ions is Tl⁺: 100 μg/L; Tl³⁺: 10 μg/L; Ca²⁺: 15 mg/L; Mg²⁺: 10 mg/L; Na⁺: 22 mg/L; K⁺: 3 mg/L; and the pH value of the water is 5. Adding in an appropriate amount of NaOH solution to adjust the pH value to 7, and then filtering the thallium-polluted water before channeling it through the filtering bed. The size of the filtering bed is L100×B50×H400 mm; it is packed with 1000 mL (about 1450 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 8% (calculated in manganese), while the grain size of the said manganese oxide (above 90%) is 10-70 nm. Controlling the temperature at 35±5° C. and channeling the water polluted with trace thallium through the resin bed at the flow rate of 40 BV/h; the total treatment capacity is 3900 BV and the total thallium in the effluent is lower than 0.1 μg/L.

Controlling the temperature at 50 t 5° C. and co-currently introducing 5000 mL of mixed solution of 0.5% HCl and 5% Ca(NO₃)₂ (by mass concentration) at the flow rate of 2000 mL/h through the resin bed for desorption; the desorption rate is higher than 99%.

### Embodiment 18

Channeling the pretreated water polluted with trace thallium through a polystyrene filtering bed packed with polymer-based nanosized manganese oxide. In the water polluted with trace thallium, the concentration of respective ions is Tl⁺: 65 μg/L; Tl³⁺: 3 μg/L; Ca²⁺: 5 mg/L; Mg²⁺: 7 mg/L; Na⁺: 9 mg/L; K⁺: 2 mg/L; and the pH value of the water is 4.5. Adding in an appropriate amount of NaOH solution to adjust the pH value to 7.5, and then filtering the thallium-polluted water before channeling it into the adsorption column for adsorption. The size of adsorption column is o50×360 mm; it is packed with 100 mL (about 141 g) of wet material of polymer-based nanosized manganese oxide. The carrier of the said material is D113 resin manufactured by (China) Yongtai Environmental Protection Science and Technology Co., Ltd.; the resin is a type of macroporous acrylic acid series weakly acidic cation exchange resin, and its total exchange capacity, grain size and wet apparent density are 11.8 mmol/g, 0.35-0.55 mm and 0.72-0.8 g/mL respectively; the loading rate of manganese oxide in the resin is 9.1% (calculated in manganese), while the grain size of the said manganese oxide (above 85%) is 10-60 nm. Controlling the temperature at 45±5° C. and channeling the water polluted with trace thallium through the resin bed at the flow rate of 45 BV/h; the total treatment capacity is 5950 BV and the total thallium in the effluent is lower than 0.1 μg/L.

Controlling the temperature at 4015° C. and co-currently introducing 1000 mL of mixed solution of 0.8% HCl and 4% Ca(NO₃)₂ (by mass concentration) at the flow rate of 200 mL/h through the resin bed for desorption; the desorption rate is higher than 99%.

### Embodiment 19

Channeling the pretreated water polluted with trace thallium through a polystyrene filtering bed packed with polymer-based nanosized manganese oxide. In the water polluted with trace thallium, the concentration of respective ions is Tl⁺: 350 μg/L; Tl³⁺: 25 μg/L; Ca²⁺: 36 mg/L; Mg²⁺: 27 mg/L; Na⁺: 45 mg/L; K⁺: 5 mg/L; and the pH value of the water is 8.5. Adding in an appropriate amount of HCl solution to adjust the pH value to 6.5, and then filtering the thallium-polluted water before channeling it into the adsorption column for adsorption. The size of adsorption column is o32×360 mm; it is packed with 50 mL (about 67 g) of wet material of polymer-based nanosized manganese oxide. The carrier of the said material is D113 resin manufactured by (China) Yongtai Environmental Protection Science and Technology Co., Ltd.; the resin is a type of macroporous acrylic acid series weakly acidic cation exchange resin, and its total exchange capacity, grain size and wet apparent density are 11.8 mmol/g, 0.35-0.55 mm and 0.72-0.8 g/mL respectively; the loading rate of manganese oxide in the resin is 11.7% (calculated in manganese), while the grain size of the said manganese oxide (above 85%) is 100-150 nm. Controlling the temperature at 25±5° C. and channeling the water polluted with trace thallium through the resin bed at the flow rate of 20 BV/h; the total treatment capacity is 1250 BV and the total thallium in the effluent is lower than 0.1 μg/L.

Controlling the temperature at 20 to ° C. and co-currently introducing 600 mL of mixed solution of 0.9% HCl and 5% Ca(NO₃)₂ (by mass concentration) at the flow rate of 400 mL/h through the resin bed for desorption; the desorption rate is higher than 98.7%.

### Embodiment 20

Channeling the pretreated water polluted with trace thallium through a polystyrene filtering bed packed with polymer-based nanosized manganese oxide material. In the water polluted with trace thallium, the concentration of respective ions is Tl⁺: 45 μg/L; Tl³⁺: 5 μg/L; Ca²⁺: 4 mg/L; Mg²⁺: 2 mg/L; Na⁺: 15 mg/L; K⁺: 1 mg/L; and the pH value of the water is 5. Adding in an appropriate amount of NaOH solution to adjust the pH value to 7, and then filtering the thallium-polluted water before channeling it through the filtering bed. The size of the filtering bed is L100×B50×H400 mm; it is packed with 1000 mL (about 1425 g) of wet material of polymer-based nanosized manganese oxide. The carrier of the said material is Amberlitte IR 252 manufactured by (U.S.) Rohm Haas Company; the loading rate of manganese oxide is 12.8% (calculated in manganese), while the grain size of the said manganese oxide (above 85%) is 100-150 nm. Controlling the temperature at 15±5° C. and channeling the water polluted with trace thallium through the resin bed at the flow rate of 70 BV/h; the total treatment capacity is 7200 BV and the total thallium in the effluent is lower than 0.1 μg/L.

Controlling the temperature at 55±5° C. and co-currently introducing 8000 mL of mixed solution of 0.5% HCl and 3% Ca(NO₃)₂ (by mass concentration) at the flow rate of 500 mL/h through the resin bed for desorption; the desorption rate is higher than 99%.

### Embodiment 21

Channeling the pretreated water polluted with trace thallium through a polystyrene filtering bed packed with polymer-based nanosized manganese oxide. In the water polluted with trace thallium, the concentration of respective ions is Tl⁺: 45 μg/L; Tl³⁺: 3 μg/L; Ca²⁺: 7 mg/L; Mg²⁺: 5 mg/L; Na⁺: 14 mg/L; K⁺: 1 mg/L; and the pH value of the water is 5. Adding in an appropriate amount of NaOH solution to adjust the pH value to 7.5, and then filtering the thallium-polluted water before channeling it through the filtering bed. The size of the filtering bed is L100×B50×H400 mm; it is packed with 1000 mL (about 1420 g) of wet material of polymer-based nanosized manganese oxide. The carrier of the said material is D113 resin manufactured by (China) Yongtai Environmental Protection Science and Technology Co., Ltd.; the resin is a type of macroporous acrylic acid series weakly acidic cation exchange resin, and its total exchange capacity, grain size and wet apparent density are 11.8 mmol/g, 0.35-0.55 mm and 0.72-0.8 g/mL respectively; the loading rate of manganese oxide in the resin is 11.8% (calculated in manganese), while the grain size of the said manganese oxide (above 85%) is 50-100 nm. Controlling the temperature at 25±5° C. and channeling the water polluted with trace thallium through the resin bed at the flow rate of 75 BV/h; the total treatment capacity is 7500 BV and the total thallium in the effluent is lower than 0.1 μg/L.

Controlling the temperature at 45 a 1° C. and co-currently introducing 8000 mL of mixed solution of 0.3% HCl and 3% Ca(NO₃)₂ (by mass concentration) at the flow rate of 500 mL/h through the resin bed for desorption; the desorption rate is higher than 99%.

### Embodiment 22

Channeling the pretreated water polluted with trace thallium through a polystyrene filtering bed packed with polymer-based nanosized manganese oxide. In the water polluted with trace thallium, the concentration of respective ions is Tl⁺: 15 μg/L; Tl³⁺: 2 μg/L; Ca²⁺: 2 mg/L; Mg²⁺: 1 mg/L; Na⁺: 9 mg/L; K⁺: 1 mg/L; and the pH value of the water is 6. Adding in an appropriate amount of NaOH solution to adjust the pH value to 8.5, and then filtering the thallium-polluted water before channeling it through the filtering bed. The size of the filtering bed is L100×B100×H400 mm; it is packed with 2500 mL (about 3400 g) of wet material of polymer-based nanosized manganese oxide. The carrier of the said material is D113 resin manufactured by (China) Yongtai Environmental Protection Science and Technology Co., Ltd.; the resin is a type of macroporous acrylic acid series weakly acidic cation exchange resin, and its total exchange capacity, grain size and wet apparent density are 11.8 mmol/g, 0.35-0.55 mm and 0.72-0.8 g/mL respectively; the loading rate of manganese oxide in the resin is 8.2% (calculated in manganese), while the grain size of the said manganese oxide (above 85%) is 5-60 nm. Controlling the temperature at 15±5° C. and channeling the water polluted with trace thallium through the resin bed at the flow rate of 90 BV/h; the total treatment capacity is 15500 BV and the total thallium in the effluent is lower than 0.1 μg/L.

Controlling the temperature at 20 ta ° C. and co-currently introducing 25000 mL of mixed solution of 0.5% HCl and 5% Ca(NO₃)₂ (by mass concentration) at the flow rate of 2000 mL/h through the resin bed for desorption; the desorption rate is higher than 99%.

### Embodiment 23

Channeling the pretreated water polluted with trace thallium through a polystyrene adsorption column packed with polymer-based nanosized manganese oxide material. In the water polluted with trace thallium, the concentration of respective ions is Tl⁺: 70 μg/L; Tl³⁺: 5 μg/L; Ca²⁺: 10 mg/L; Mg²⁺: 6 mg/L; Na⁺: 13 mg/L; K⁺: 6 mg/L; and the pH value of the water is 9.5. Adding in an appropriate amount of HCl solution to adjust the pH value to 8.5, and then filtering the thallium-polluted water before channeling it into the adsorption column for adsorption. The size of adsorption column is o 20×300 mm; it is packed with 20 mL (about 25 g) of wet material of polymer-based nanosized manganese oxide. The carrier of the said material is D001 resin manufactured by (China) Hangzhou Zhengguang Resin Co., Ltd.; this resin takes polystyrene-divinylbenzene as its matrix, and its crosslinkage is 8% and the specific surface area 20.2 m²/g, the average pore size 23.2 nm, the content of surface-bonded sulfonates 4.1 mmol/g; the loading rate of manganese oxide is 85% (calculated in manganese), while the grain size of the said manganese oxide (above 90%) is 20-100 nm. Controlling the temperature at 35±5° C. and channeling the water polluted with trace thallium through the resin bed at the flow rate of 45 BV/h; the total treatment capacity is 4600 BV and the total thallium in the effluent is lower than 0.1 μg/L.

Controlling the temperature at 3515° C. and co-currently introducing 400 mL of mixed solution of 0.6% HCl and 4% Ca(NO₃)₂ (by mass concentration) at the flow rate of 200 mL/h through the resin bed for desorption; the desorption rate is higher than 99%.

### Embodiment 24

Channeling the pretreated water polluted with trace thallium through a polystyrene filtering bed packed with polymer-based nanosized manganese oxide. In the water polluted with trace thallium, the concentration of respective ions is Tl⁺: 280 μg/L; Tl³⁺: 15 μg/L; Ca²⁺: 45 mg/L; Mg²⁺: 30 mg/L; Na⁺: 15 mg/L; K⁺: 3 mg/L; and the pH value of the water is 8.5. Adding in an appropriate amount of HCl solution to adjust the pH value to 5.5, and then filtering the thallium-polluted water before channeling it into the adsorption column for adsorption. The size of adsorption column is o 32×360 mm; it is packed with 50 mL (about 68 g) of wet material of polymer-based nanosized manganese oxide. The carrier of the said material is Amberlitte IR 252 manufactured by (U.S.) Rohm Haas Company; the loading rate of manganese oxide is 14.2% (calculated in manganese), while the grain size of the said manganese oxide (above 85%) is 120-180 nm. Controlling the temperature at 25±5° C. and channeling the water polluted with trace thallium through the resin bed at the flow rate of 20 BV/h; the total treatment capacity is 1500 BV and the total thallium in the effluent is lower than 0.1 μg/L.

Controlling the temperature at 301 treatment capacity is 1500 BV and the total thalsolution of 0.7% HCl and 3.5% Ca(NO₃)₂ (by mass concentration) at the flow rate of 400 mL/h through the resin bed for desorption; the desorption rate is higher than 99%.

### Embodiment 25

Channeling the pretreated water polluted with trace thallium through a polystyrene filtering bed packed with polymer-based nanosized manganese oxide. In the water polluted with trace thallium, the concentration of respective ions is Tl⁺: 125 μg/L; Tl³⁺: 10 μg/L; Ca²⁺: 15 mg/L; Mg²⁺: 6 mg/L; Na⁺: 18 mg/L; K⁺: 2 mg/L; and the pH value of the water is 5.5. Adding in an appropriate amount of NaOH solution to adjust the pH value to 7.5, and then filtering the thallium-polluted water before channeling it into the adsorption column for adsorption. The size of adsorption column is φ20×300 mm; it is packed with 20 mL (about 26 g) of wet material of polymer-based nanosized manganese oxide. The carrier of the said material is Amberlitte IR 252 manufactured by (U.S.) Rohm Haas Company; the loading rate of manganese oxide is 6.7% (calculated in manganese), while the grain size of the said manganese oxide (above 80%) is 20-70 nm. Controlling the temperature at 10±2° C. and channeling the water polluted with trace thallium through the resin bed at the flow rate of 35 BV/h; the total treatment capacity is 3200 BV and the total thallium in the effluent is lower than 0.1 μg/L.

Controlling the temperature at 20 ot ° C. and co-currently introducing 180 mL of mixed solution of 0.7% HCl and 5% Ca(NO₃)₂ (by mass concentration) at the flow rate of 100 mL/h through the resin bed for desorption; the desorption rate is higher than 98.9%.

### Embodiment 26

Channeling the pretreated water polluted with trace thallium through a polystyrene filtering bed packed with polymer-based nanosized manganese oxide. In the water polluted with trace thallium, the concentration of respective ions is Tl⁺: 12 μg/L; Tl³⁺: 1 μg/L; Ca²⁺: 3 mg/L; Mg²⁺: 1 mg/L; Na⁺: 6 mg/L; K⁺: 1 mg/L; and the pH value of the water is 6. Adding in an appropriate amount of NaOH solution to adjust the pH value to 8.5, and then filtering the thallium-polluted water before channeling it through the filtering bed. The size of the filtering bed is L100×B100×H400 mm; it is packed with 2500 mL (about 3400 g) of wet material of polymer-based nanosized manganese oxide. The carrier of the said material is Amberlitte IR 252 manufactured by (U.S.) Rohm Haas Company; the loading rate of manganese oxide is 7.5% (calculated in manganese), while the grain size of the said manganese oxide (above 85%) is 5-60 nm. Controlling the temperature at 45±5° C. and channeling the water polluted with trace thallium through the resin bed at the flow rate of 90 BV/h; the total treatment capacity is 15400 BV and the total thallium in the effluent is lower than 0.1 μg/L.

Controlling the temperature at 40 ta ° C. and co-currently introducing 25000 mL of mixed solution of 0.9% HCl and 4.5% Ca(NO₃)₂ (by mass concentration) at the flow rate of 2000 mL/h through the resin bed for desorption; the desorption rate is higher than 99%.

### Embodiment 27

Channeling the pretreated water polluted with trace thallium through a polystyrene filtering bed packed with polymer-based nanosized manganese oxide. In the water polluted with trace thallium, the concentration of respective ions is Tl⁺: 140 the wate³⁺: 7 μg/L; Ca²⁺: 12 mg/L; Mg²⁺: 6 mg/L; Na⁺: 28 mg/L; K⁺: 2 mg/L; and the pH value of the water is 4.5. Adding in an appropriate amount of NaOH solution to adjust the pH value to 7, and then filtering the thallium-polluted water before channeling it into the adsorption column for adsorption. The size of adsorption column is φ20×300 mm; it is packed with 20 mL (about 22 g) of wet material of polymer-based nanosized manganese oxide. The carrier of the said material is D113 resin manufactured by (China) Yongtai Environmental Protection Science and Technology Co., Ltd.; the resin is a type of macroporous acrylic acid series weakly acidic cation exchange resin, and its total exchange capacity, grain size and wet apparent density are 11.8 mmol/g, 0.35-0.55 mm and 0.72-0.8 g/mL respectively; the loading rate of manganese oxide in the resin is 3.7% (calculated in manganese), while the grain size of the said manganese oxide (above 80%) is 5-40 nm. Controlling the temperature at 10±2° C. and channeling the water polluted with trace thallium through the resin bed at the flow rate of 40 BV/h; the total treatment capacity is 2950 BV and the total thallium in the effluent is lower than 0.1 μg/L.

Controlling the temperature at 10 a 1° C. and co-currently introducing 180 mL of mixed solution of 0.7% HCl and 4% Ca(NO₃)₂ (by mass concentration) at the flow rate of 100 mL/h through the resin bed for desorption; the desorption rate is higher than 98.5%.

### Embodiment 28

Channeling the pretreated water polluted with trace thallium through a polystyrene filtering bed packed with polymer-based nanosized manganese oxide. In the water polluted with trace thallium, the concentration of respective ions is Tl⁺: 140 anese ox³⁺: 7 μg/L; Ca²⁺: 12 mg/L; Mg²⁺: 6 mg/L; Na⁺: 28 mg/L; K⁺: 2 mg/L; and the pH value of the water is 4.5. Adding in an appropriate amount of NaOH solution to adjust the pH value to 7, and then filtering the thallium-polluted water before channeling it into the adsorption column for adsorption. The size of adsorption column is φ20×300 mm; it is packed with 20 mL (about 22 g) of wet material of polymer-based nanosized manganese oxide. The carrier of the said material is D113 resin manufactured by (China) Yongtai Environmental Protection Science and Technology Co., Ltd.; the resin is a type of macroporous acrylic acid series weakly acidic cation exchange resin, and its total exchange capacity, grain size and wet apparent density are 11.8 mmol/g, 0.35-0.55 mm and 0.72-0.8 g/mL respectively; the loading rate of manganese oxide in the resin is 3.7% (calculated in manganese), while the grain size of the said manganese oxide (above 80%) is 5-40 nm. Controlling the temperature at 10±2° C. and channeling the water polluted with trace thallium through the resin bed at the flow rate of 40 BV/h; the total treatment capacity is 2950 BV and the total thallium in the effluent is lower than 0.1 μg/L.

Controlling the temperature at 10 a 1° C. and co-currently introducing 180 mL of mixed solution of 0.3% NaOH and 4% NaClO (by mass concentration) at the flow rate of 100 mL/h through the resin bed for desorption; the desorption rate is higher than 98.5%.

1. A deep purification method for removing trace thallium in water by using polymer-based nanosized manganese oxide, comprising:
(A) adjusting a pH value of the water polluted with trace thallium to 5-8.5, and then filtering the water;
(B) channeling the water treated by step (A) through a packed tower or filtering bed packed with a polymer-based nanosized manganese oxide so that the thallium in the water is selectively adsorbed upon the polymer-based nanosized manganese oxide, wherein an adsorption temperature is kept at 5-50° C. and the flow rate at 10-100 BV/h during step (B); and
(C) stopping the adsorption process when thallium in the effluent reaches a leak point, and then using a binary solution of HCl-Ca(NO₃)₂ or NaOH—NaClO as a desorption agent and starting desorption and regeneration process for the packing material of the polymer-based nanosized manganese oxide, wherein a mass concentration of the binary solution of HCl—Ca(NO₃)₂ or NaOH—NaClO is 0.3-5%, the regeneration temperature is kept at 10-60° C., and the regeneration flow rate is at 0.5-10 BV/h, further wherein the regenerated packing material is used repeatedly.

2. The deep purification method for removing trace thallium in water by using the polymer-based nanosized manganese oxide as defined in claim 1, wherein thallium in the thallium-polluted water mentioned in step (A) exists in the form of either monovalent cation (Tl⁺) or trivalent cation (Tl³⁺); its total concentration is 0.01-0.5 mg/L; the respective concentration of all coexisting competitive cations such as K⁺, Ca²⁺, Mg²⁺, Na⁺ and Sr²⁺ is lower than 50 mg/L.

3. The deep purification method for removing trace thallium in water by using the polymer-based nanosized manganese oxide as defined in claim 2, wherein a carrier of the polymer-based nanosized manganese oxide is a type of cation exchange resin.

4. The deep purification method for removing trace thallium in water by using the polymer-based nanosized manganese oxide as defined in claim 3, wherein the carrier of the polymer-based nanosized manganese oxide is D001, D113, 001×7 or Amberlite IR 252 resin.

5. The deep purification method for removing trace thallium in water by using the polymer-based nanosized manganese oxide as defined in claim 1, wherein a grain size of manganese oxide in the polymer-based nanosized manganese oxide is 5-190 nm and a loading rate of manganese oxide is 4-15%.

6-7. (canceled)
